(19) United States
(12) Patent Application Publication
(10) Pub. No.: US 2025/0172818 A1
(43) Pub. Date: May 29, 2025

(54) SIMULTANEOUS POLARIZED LIGHT VIEWING/IMAGING THROUGH A SPLIT POLARIZER

(71) Applicant: University of South Florida, Tampa, FL (US)

(72) Inventor: Katharine L. Hanlon-Nielsen, Sebastian, FL (US)

(21) Appl. No.: 19/004,730

(22) Filed: Dec. 30, 2024

Related U.S. Application Data
(63) Continuation of application No. PCT/US2023/026715, filed on Jun. 30, 2023.
(60) Provisional application No. 63/357,350, filed on Jun. 30, 2022.

(51) Int. Cl. G02B 27/28; B64U 20/87; B64U 101/30; G01C 15/00

(52) U.S. Cl. CPC G02B 27/288; B64U 20/87; G01C 15/00; G02B 27/286; B64U 2101/30

(57) ABSTRACT

Described herein relates to a system and method of filtering a polarized light through at least a polarization orientation for simultaneous viewing. The polarizing light filter apparatus may comprise at least one light source and/or a split polarizer configured to provide the polarization orientation of incident light. Light source may be configured to emit the incident light toward a structure, such that the incident light may be reflected off the structure through the split polarizing comprising a first polarization orientation (e.g., parallel) and/or a second polarizing orientation (e.g., cross). The reflected light may travel through the split polarizer, providing a simultaneous view of the first polarization orientation and/or the second polarization orientation, in real-time. Moreover, the simultaneous view of the polarized light may allow for a more detailed visual experience as well as optimize the ability to determine which orientation of light best illuminates a feature of interest.

### CROSS-REFERENCE TO RELATED APPLICATIONS

This nonprovisional application is a continuation of International PCT Application No. PCT/US2023/026715 entitled “SIMULTANEOUS POLARIZED LIGHT VIEWING/IMAGING THROUGH A SPLIT POLARIZER,” filed Jun. 30, 2023, by the same inventor, which claims the benefit of U.S. Provisional Application No. 63/357,350 entitled “SIMULTANEOUS POLARIZED LIGHT VIEWING/IMAGING THROUGH A SPLIT POLARIZER,” filed Jun. 30, 2022, by the same inventor, all of which is incorporated herein by reference, in its entirety, for all purposes.

### BACKGROUND OF THE INVENTION

### 1. Field of the Invention

This invention relates, generally, to polarized light systems. More specifically, it relates to a system and method of filtering a polarized light through at least two polarization orientations for simultaneous viewing.

### 2. Brief Description of the Prior Art

Polarized light is used for specialized applications in a number of fields. In medical and forensic applications (e.g., Tissue viewing), scientific applications (e.g., Microscopy, biology and geology, agriculture), engineering applications (e.g., Ice crystal formation, plastics manufacturing), and for imaging applications (e.g., Medical, aerial and underwater photography). With so many applications for polarized light in medicine, science and industry, several configurations and systems have been designed to harness the power polarized light has for separating surface and subsurface compartments as well as separating anisotropic and isotropic materials.

Currently known techniques using polarized lights typically have a single orientation (e.g., a crossed orientation), a switch allowing a change back and forth between orientation states, or a dial that can be rotated along a 90 degree axis between crossed (S) and parallel (P) with the elliptical states of polarization occurring between. This invention eliminates the need to switch or rotate between states, interact with the device, or perform complex decision-making regarding what orientation illustrates the subject most appropriately for the given application. The invention addresses the problem of complexity in polarized light systems and/or allows for hands-free viewing, examination, and/or photography.

Accordingly, what is needed is an efficient and readily replaceable polarized light apparatus, such that multiple polarization orientations of polarized light may be viewed simultaneously. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to a polarizing light filter apparatus. In an embodiment, the polarizing light filter apparatus may comprise the following: (a) a housing comprising at least one viewing window; (b) at least one light source temporarily affixed to at least one portion of a surface of the housing, the at least one light source configured to output an incident light toward a structure; and (c) a split polarizer temporarily affixed to at least one alternative portion of the surface of the housing, the split polarizer being in mechanical communication with the at least one viewing window. In this embodiment, the split polarizer may be configured to convert an orientation of the incident light into at least two polarized orientations. In addition, in this embodiment, when the incident light is outputted toward the structure, the split polarizer may be configured to receive a reflected incident light, such that at least one user may view the at least two polarized orientations of the structure, in real-time.

In some embodiments, the split polarizer may comprise a first polarizing filter and/or a second polarizing filter, or both. In this manner the first polarizing filter may comprise a counterclockwise polarization, while the second polarizing filter may comprise a clockwise polarization. As such, in these other embodiments, the first polarizing filter may be configured to highlight at least one superficial aspect of the structure, whereas, the second polarizing filter may be configured to highlight at least one depth aspect of the structure.

Additionally, in some embodiments, the polarizing light filter apparatus may further comprise an image capturing device in mechanical communication with the at least one viewing window and/or the split polarizer. In these other embodiments, the image capturing device may comprise a light receiver configured to obtain and/or record the polarized incident light translated through the split polarizer, such that the at least two polarized orientations of the structure may be displayed simultaneously, in real-time, within an image and/or a video.

In some embodiments, the polarizing light filter apparatus may further comprise a computing device having at least one processor communicatively coupled to the image capturing device. As such, in these other embodiments, subsequent to the light receiver obtaining and/or recording the at least two polarized orientations of the structure within the image and/or the video, the image capturing device may be configured to transmit the at least one obtained polarized orientation of the structure to the computing device. In this manner, in these other embodiments, the computing device may be configured to automatically display, in real-time, the at least one obtained polarized orientation of the structure on a display device associated with the computing device. In some embodiments, the at least one light source is configured to output a coherent light. In some embodiments, the coherent light comprises a laser.

Moreover, another aspect of the present disclosure pertains to a system for viewing, in real time, at least two polarized orientations of a structure. In an embodiment, the system may comprise the following: (a) a housing comprising at least one viewing window; (b) at least one light source temporarily affixed to at least one portion of a surface of the housing, the at least one light source configured to output an incident light toward a structure; (c) a split polarizer temporarily affixed to at least one alternative portion of the surface of the housing, the split polarizer being in mechanical communication with the at least one viewing window; and (d) an image capturing device in mechanical communication with the at least one viewing window and/or the split polarizer, the image capturing device comprising at least one light receiver. In this embodiment, the split polarizer may be configured to convert an orientation of the incident light into at least two polarized orientations, such that when the incident light is output toward the structure, the split polarizer may be configured to receive the reflected incident light. In this embodiment, the light receiver may also be configured to obtain and/or record the polarized incident light translated through the split polarizer, such that the at least two polarized orientations of the structure may be displayed simultaneously, in-real time, within an image and/or a video, in real-time.

In some embodiments, the split polarizer may comprise a first polarizing filter and/or a second polarizing filter, or both. In this manner the first polarizing filter may comprise a counterclockwise polarization, while the second polarizing filter may comprise a clockwise polarization. As such, in these other embodiments, the first polarizing filter may be configured to highlight at least one superficial aspect of the structure. whereas, the second polarizing filter may be configured to highlight at least one depth aspect of the structure. In some embodiments, the at least one light source is configured to output a coherent light.

In some embodiments, the polarizing light filter apparatus may further comprise a computing device having at least one processor communicatively coupled to the image capturing device. As such, in these other embodiments, subsequent to the light receiver obtaining and/or recording the at least two polarized orientations of the structure within the image and/or the video, the image capturing device may be configured to transmit the at least one obtained polarized orientation of the structure to the computing device. In this manner, in these other embodiments, the computing device may be configured to automatically display, in real-time, the at least one obtained polarized orientation of the structure on a display device associated with the computing device.

Furthermore, an additional aspect of the present disclosure pertains to a method for viewing, in real time, at least two polarized orientations of a structure. In an embodiment, the method may comprise the following steps: (a) providing a polarizing light filter apparatus, the polarizing light filter apparatus comprising: (1) a housing comprising at least one viewing window; (2) at least one light source temporarily affixed to at least one portion of a surface of the housing, the at least one light source configured to output an incident light toward a structure; (3) a split polarizer temporarily affixed to at least one alternative portion of the surface of the housing, the split polarizer being in mechanical communication with the at least one viewing window, such that the split polarizer may be configured to convert an orientation of the incident light into at least two polarized orientations; (b) emitting, via the at least one light source, the incident light, such that the incident light may be reflected off of the structure; (c) converting, via the split polarizer, an orientation of the reflected incident light into at least two polarized orientations as it translates through the split polarizer; and (d) viewing, via the at least one viewing window, in real-time, the at least two polarized orientations of the structure, such that the at least two polarized orientations of the structure highlights at least one superficial aspect, at least one depth aspect, or both of the structure.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a diagrammatic image of an exemplary configuration of a polarizing light filter apparatus creating a simultaneous view, according to an embodiment of the present disclosure.

FIG. 2 is a diagrammatic image depicting an alternative exemplary configuration of the polarizing light filter apparatus of FIG. 1, according to an embodiment of the present disclosure.

FIG. 3A is a first exemplary image of a first polarization orientation and a second polarization orientation of a polarized light of a structure where the first polarization orientation and the second polarization orientation of the structure are shown simultaneously, according to an embodiment of the present disclosure.

FIG. 3B is a second exemplary image of a first polarization orientation and a second polarization orientation of a polarized light of a structure where the first polarization orientation and the second polarization orientation of the structure are shown simultaneously, according to an embodiment of the present disclosure.

FIG. 4 is a diagrammatic image depicting a third exemplary configuration of a polarizing light filter apparatus, according to an embodiment of the present disclosure.

FIG. 5 is a diagrammatic image depicting a fourth exemplary configuration of a polarizing light filter apparatus, according to an embodiment of the present disclosure.

FIG. 6 is a diagrammatic image depicting a fifth exemplary configuration of a polarizing light filter apparatus, according to an embodiment of the present disclosure.

FIG. 7 is a diagrammatic image depicting a sixth exemplary configuration of a polarizing light filter apparatus, according to an embodiment of the present disclosure.

FIG. 8 is a diagrammatic image depicting a seventh exemplary configuration of a polarizing light filter apparatus, according to an embodiment of the present disclosure.

FIG. 9 is a diagrammatic image depicting an eighth exemplary configuration of a polarizing light filter apparatus, according to an embodiment of the present disclosure.

FIG. 10 is a diagrammatic image depicting a ninth exemplary configuration of a polarizing light filter apparatus, according to an embodiment of the present disclosure.

FIG. 11 is an exemplary flowchart depicting the steps of a method for viewing and/or capturing a split configuration polarization view, via a polarizing light filter apparatus, according to an embodiment of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention. Elements/components shown in diagrams are illustrative of exemplary embodiments of the disclosure and are meant to avoid obscuring the disclosure. Any headings, used herein, are for organizational purposes only and shall not be used to limit the scope of the description or the claims. Furthermore, the use of certain terms in various places in the specification, described herein, are for illustration and should not be construed as limiting.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. The techniques introduced here can be embodied as special-purpose hardware (e.g. circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compacts disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

As used herein, “computing device” refers to any electronic device known in the art capable of wired and/or wireless data transmission and/or is capable of graphically displaying data to a viewing user. Non-limiting examples of a “computing device” may include a personal computer, a laptop, a mobile device, and/or a medical instrument. For ease of reference, the exemplary embodiment described herein refers to a personal computer and/or a mobile device, but this description should not be interpreted as exclusionary of other computing devices

As used herein, the term “communicatively coupled” refers to any coupling mechanism known in the art configured to exchange information using methods and devices known in the art. Non-limiting examples of “communicatively coupled” may include Wi-Fi, Bluetooth, wired connections, wireless connection, and/or magnets. For ease of reference, the exemplary embodiment described herein refers to Wi-Fi and/or Bluetooth, but this description should not be interpreted as exclusionary of other electrical coupling mechanisms.

The term “about”, “approximately”, or “roughly” as used herein refers to being within an acceptable error range for the particular value as determined by one of ordinary skill in the art, which will depend in part on how the value is measured or determined, i.e., the limitations of the measurement system, i.e., the degree of precision required for a particular purpose, such as additive manufacturing. As used herein “about” refers to within ±15% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Polarizing Light Filter Apparatus

The present disclosure pertains to an apparatus and method for filtering an incident light through at least two polarization orientations for simultaneous viewing of the at least two polarization orientations. In an embodiment, the polarizing light filter apparatus may comprise a computing device, the computing device comprising at least one processor, communicatively coupled to at least one image capturing device, such that at least one recorded and/or captured image comprising the at least two polarization orientations may be automatically displayed on the image capturing device and/or a display device associated with the computing device, in real-time.

In an embodiment, the polarizing light filter apparatus may comprise a split polarizer comprising at least one polarizing filter and/or at least one light source. The split polarizer may comprise at least one polarizing filter (e.g., a Quarter Wave plate (hereinafter “QWP”)), such that an incident light may comprise a polarization orientation associated with at least one polarizing filter, as it travels through the polarization orientation of the split polarizing filter. In this embodiment, the split polarizer filter may comprise a first polarization filter on a front side of the split polarizer and/or a second polarizing filter on a back side of the split polarizer. As such, when the incident light (e.g., incoherent light) is reflected off a structure under observation, a first half of the viewing field may receive a backscattered light (e.g., coherent light and/or polarized light) oriented as a first polarization orientation of polarized light, a second half may receive a second polarization orientation of polarized light.

Non-limiting examples of the polarization orientation may comprise, but are not limited to, a cross-polarized orientation, a parallel-polarized orientation, an elliptical-polarized orientation, and/or any polarized orientation known in the art. For ease of reference, the exemplary embodiment described herein refers to the parallel-polarized orientation and the cross-polarized orientation, but this description should not be interpreted as exclusionary of other polarization orientations.

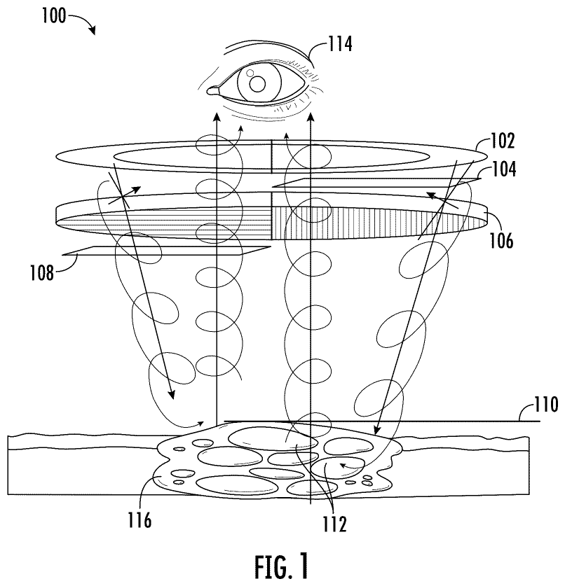

FIG. 1 depicts a diagrammatic image of the polarizing light filter apparatus 100, according to an embodiment of the present disclosure. In this embodiment, polarizing light filter apparatus 100 may comprise a split circular polarizing filter 104, 108 which creates a simultaneous view of the first polarization orientation and the second polarization orientation of polarized light. As such, a light source 102 may emit an incident light (e.g., incoherent light and/or coherent light) which may pass through a split polarizer 106 such that the incident may change orientation. In this manner, split polarizer 106 may be configured to adhere to the shape of a viewing device 114, such that the first polarization and/or the second polarization of the polarized light from light source 102 may be configured to encapsulate the entire viewing area, captured and/or recorded image and/or video. For example, in some embodiments, when passing through polarizing filter 104 configured to output a first polarization orientation (e.g., parallel-polarized orientation), the incident light of light source 102 may comprise a counterclockwise polarization (e.g., left-handed circular polarization). In this same manner, when the incident light passes through polarizing filter 108 configured to output a second polarization orientation (e.g., a cross-polarized orientation), the incident light may comprise a clockwise orientation (e.g., right handed circular polarization).

In an embodiment, as shown in FIG. 1, the incident light (e.g., incoherent light) from light source 102 may be reflected off at least one superficial aspect 110 and/or at least one deep aspect 112 of structure 116, such that the incident light contacts at least one superficial aspect 110 and/or at least one deep aspect 112 of structure 116, such that the backscattered light maintains its orientation memory and may pass back through split polarizer 106 and/or at least one polarizing filter 104, 108, via the same polarized orientation which it initially entered the split polarizer 106 and/or the at least one polarizing filter 104, 108.

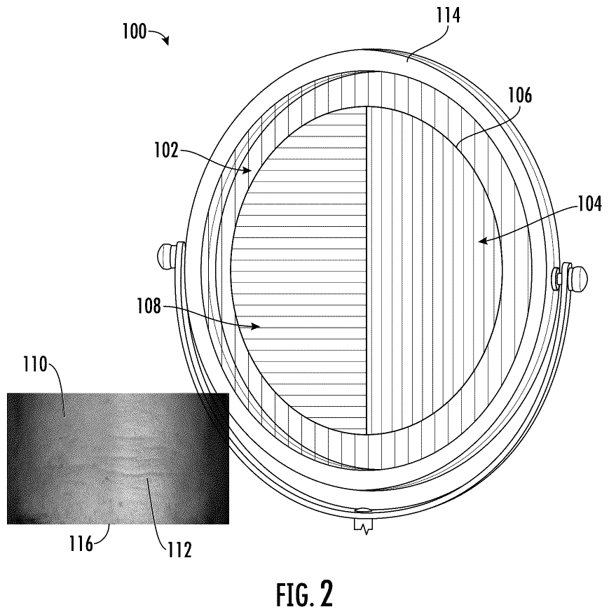

FIG. 2 depicts a diagrammatic image depicting an alternative exemplary configuration of polarizing light filter apparatus 100, according to an embodiment of the present disclosure. In an embodiment, polarizing light filter apparatus 100 may comprise at least one alternative polarizer disposed about at least one portion of light source 102. The at least one alternative polarizer comprising a linear polarization. In this manner, the incident light supplied by light source 102 may be configured to be linearly polarized via the at least one alternative polarizer, such that the linear polarized light may be configured to reflect off structure 116. In this embodiment, the linear polarized light and/or the backscattered linear polarized light may then be configured to be received by at least one polarizer filter 104, 108 of split polarizer 106, such that the reflected light may pass through a first polarization orientation (e.g. parallel-polarization) and/or a second polarization orientation (e.g., cross-polarization) of split polarizer 106. Moreover, in this embodiment, the linear polarized incident light of light source 102 may be configured to maintain its orientation memory, such that the backscattered light from structure 116 may maintain the same orientation as the initially linear polarized incident light of light source 102 of polarizing filter apparatus 100, via the at least one alternative polarizer.

Non-limiting examples of light source 102 may comprise, but are not limited to, a magnifying loupe, a LED frame, a derma-scope, an imaging system or lens, a backlight, and/or an examination lamp. For ease of reference, the exemplary embodiment described herein refers to a LED frame, but this description should not be interpreted as exclusionary of other light sources.

Additionally, as shown in FIG. 1 and FIG. 2, in an embodiment, the reflected light may then be viewed, by measured, and/or recorded, in real-time, by at least one user, via at least one viewing window of polarizing light filter apparatus 100 and/or at least one image capturing device 114 of polarizing light filter apparatus 100. In this embodiment, image capturing device 114 may be communicatively coupled to polarizing light filter apparatus 100. In this manner, image capturing device 114 may also be communicatively coupled to a computing device comprising at least one processor, the computing device being communicatively coupled to polarizing light filter apparatus 100, such that image capturing device 114 may be configured to transmit the recorded image to the computing device. In this embodiment, the computing device may then be configured to display the recorded image and/or video on a display device associated with the computing device. As such, for example, in some embodiments the light comprising the first polarization orientation (e.g., parallel-polarized; P-Polarization) and/or the second polarization orientation (e.g., the cross-polarized; S-Polarization) may be automatically viewed and/or displayed simultaneously, in real-time, via the viewing window and/or the display device. In these other embodiments, the light comprising the first polarization orientation light and/or the second polarization may also be captured and/or recorded within a same image and/or video, via image capturing device 114 and/or the computing device.

Moreover, as shown in FIG. 2, in an embodiment, image capturing device 114 may be configured to input the first polarization orientation and/or the second polarization orientation of polarized light from light source 102, via first and/or second polarizing filter 104, 108 of split polarizer 106 of polarizing light apparatus 100. As such, the first polarization orientation and/or second polarization orientation may be interpreted simultaneously and/or in real-time by the user, via the at least one viewing window, and/or automatically by image capturing device 114. Furthermore, in this embodiment, the first polarization orientation and/or the second polarization orientation may be viewed simultaneously, in real-time, by a user, via image capturing device 114, without having to alter and/or switch between the first polarization orientation and the second polarization orientation, such that the first polarization orientation and/or the second polarization orientation may appear on the same image and/or video concurrently.

Non-limiting embodiments of image capturing device 114 may comprise, but are not limited to, a camera, a microscope, a mirror, a video recorder, a derma-scope, an aerial vehicle, an imaging system, a computing device, and/or any viewing devices known in the art which may input a polarized light. For ease of reference, the exemplary embodiment described herein refers to an imaging system, but this description should not be interpreted as exclusionary of other viewing devices.

In some embodiments, as shown in FIG. 1, individual light sources of light source 102 may be disposed behind at least one portion of split polarizer 106 to allow a user to fully view the at least two polarization orientations of the backscattered light from structure 116 without being positioned on the same side as the structure. Additionally, in some embodiments, image capturing device 114 may be communicatively coupled to the computing device associated with polarizing light filter apparatus 100, such that image capturing device 114 may be configured to transmit an electrical signal comprising the backscattered light (e.g., coherent light) reflected form structure 116. In this manner, the captured reflected light and/or subsequent image may be automatically displayed, in real-time, via the display device associated with the computing device.

In some embodiments, as shown in FIG. 2, the polarized linear light of light source 102 of polarizing light filter apparatus 100 may be configured to re-translate through the at least one polarizing filter 104, 108 of split polarizer 106, at least one additional time. As such the secondarily reflected, linearly polarized backscattered light from structure 116 may travel back through the same polarization orientation (e.g., the first polarization orientation and/or the second polarization orientation) that the linearly polarized light originally traveled through, without affecting original polarization of the linearly polarized light, via the at least one polarizing filter 104, 108 of split polarizer 106. Additionally, in these other embodiments, light source 102 may be perpendicular to the split polarizer 106, such that the reflection angle of the incident light may be minimized. Moreover, image capturing device 114 may be communicatively coupled to the computing device associated with polarizing light filter apparatus 100, such that image capturing device 114 may be configured to transmit an electrical signal comprising the linearly polarized backscattered light reflected form structure 116, such that the captured reflected light and/or subsequent image may be automatically displayed, in real-time, via the display device associated with the computing device.

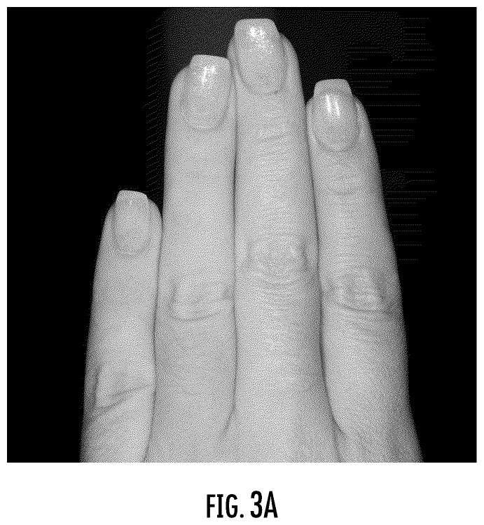

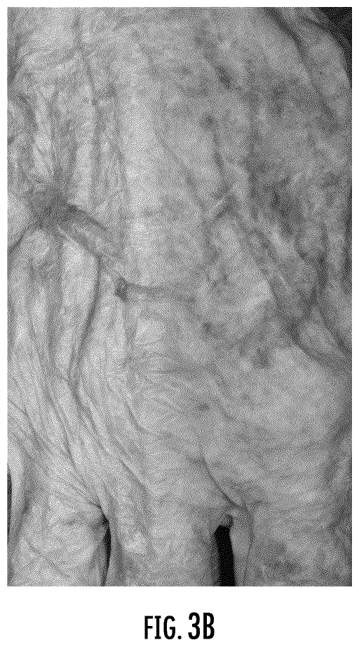

Additionally, as shown in FIG. 3A and FIG. 3B, in conjunction with FIGS. 1-2, and FIGS. 4-10, the at least two polarization orientations (e.g., first polarization orientation and/or the second polarization orientation) may affect the level of depth which the reflected light may be viewed and/or recorded via image capturing device 114 of the polarizing light filter apparatus. For example, as shown in FIGS. 1-2, in conjunction with FIGS. 3A-3B, when the incident light of light source 102 may pass through a parallel-polarization orientation (e.g., first polarizing filter 104 of split polarizer 106 of polarizing light filter apparatus 100), the incident light may reflect off of a superficial aspect 110 of the structure. In this manner, when the incident light of light source 102 passes through a crossed-polarization orientation (e.g., second polarizing filter 108 of split polarizer 106 of polarizing light filter apparatus 100), may reflect off of deep aspects 112 of the structure. Accordingly, in this embodiment, when the at least two polarization orientations of the polarized light, via split polarizer 106, enters image capturing device 114, image capturing device 114 may be configured to automatically transmit an electric signal to the computing device of polarizing light filter apparatus 100, such that the display device associated with the computing device may automatically display the recorded and/or captured image in real-time.

Additionally, in some embodiments, image capturing device 114 may be configured to allow at least one user to view, via at least one viewing window, the at least two polarization orientations and/or a level of depth of the imaged structure. For example, in some embodiments, a first side of the imaged structure may show, via the at least one viewing window of image capturing device 114 and/or the display device of polarizing light filter apparatus 100, the superficial aspects 110 of structure 116 (e.g., tissue lines and textual aspects), while a second side of the image provides the deeper aspects 112 of the structure 116 (e.g., tissue vascularity, collagen, and/or lesions).

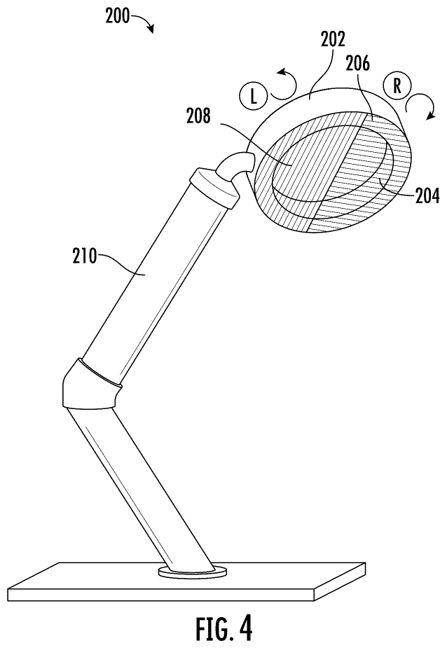

FIGS. 4-10, in conjunction with FIG. 2, depict exemplary configurations of the polarized light apparatus, according to an embodiment of the present disclosure. As such, as shown in FIG. 2, in an embodiment, split polarizer 106 may comprise a reflective surface (e.g., a mirror). As such, in this embodiment, the user may be able to view a body, a room, and/or any structure known in the art which may be viewed in a reflective surface through the split polarizer 106 of polarizing light filter apparatus 100. Additionally, the reflective surface of polarizing light filter apparatus 100 may further comprise light source 102, such that the reflective surface of split polarizer 106 of polarizing light filter apparatus 100 may be backlight. In this manner, the user may be positioned on the same side as structure 116, for simultaneous viewing in real-time, such that the user may be able to alter the position of structure 116. In addition, in this embodiment, the user may view and/or capture the at least two polarization orientations (e.g., first polarization orientation and the second polarization orientation), via at least one polarizing filter 104, 108 of split polarizer 106, of the polarized light reflected off structure 116, simultaneously and/or in real-time, via the at least one viewing window and/or image capturing device 114.

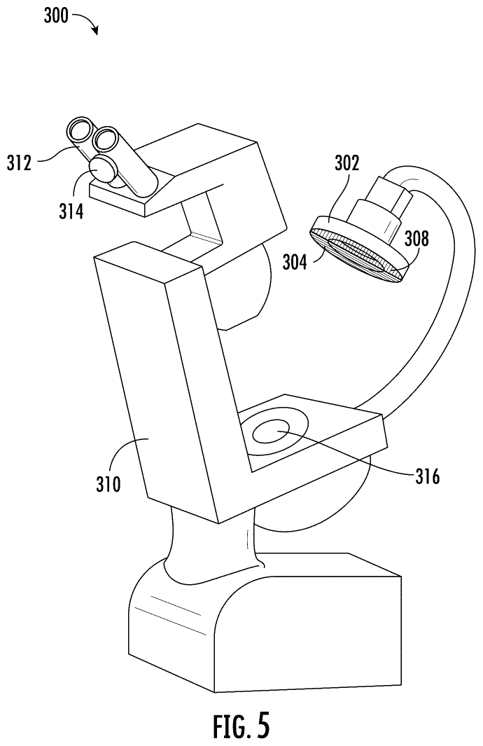

FIGS. 4-5 depicts image capturing device 210, 310 incorporated in polarizing light filter apparatus 200, 300, according to an embodiment of the present disclosure. In an embodiment, split polarizer 206, 306 and/or at least one polarizing filter 204, 208, 304, 308 may be configured to be temporarily affixed to light source 202, 302 of image capturing device 210, 310. Moreover, as shown in FIG. 5, in an embodiment, polarizing light filter apparatus 300 may comprise at least one alternative split polarizer 314 configured to be temporarily transfixed on viewing window 312 of image capturing device 310. In this embodiment, the at least two polarization orientations (e.g., first polarization orientation (e.g., parallel-polarized) and/or the second polarization orientation (e.g., cross-polarized) of the incident light (e.g., incoherent light and/or coherent light) of light source 302 may be reflected back toward the at least one alternative polarizing filter of the at least one alternative split polarizer. As such, polarizing light filter apparatus 300 may be configured to pass the backscattered light through viewing window 312. In this embodiment, at least one split polarizer 314 may be temporarily affixed to viewing window 312. In this manner, in this embodiment, polarizing light filter apparatus 300 may be configured to pass the backscattered light through the same polarization orientation that the incident light traveled through.

As shown in FIG. 5, in an embodiment, the at least one polarizing filter 304, 308 of split polarizer 306 may be configured to maintain the first polarization orientation and second polarization orientation, with opposite helicity (e.g., S-Polarization and P-Polarization). Moreover, in this embodiment, as stated above, the at least one alternative split polarizer 314 may be removably affixed to viewing window 312 of image capturing system 310 of polarizing light filter apparatus 300, such that the user may view the at least two polarization orientations (e.g., first polarization orientation and/or the second polarization orientation) of polarized light of structure 316 and/or a magnified view of structure 316, via viewing window 312, based on the user preference. In this manner, the user may view and/or capture the image comprising the at least two polarization orientations (e.g., first polarization orientation and/or the second polarization orientation) of polarized light of structure 316 simultaneously, in real-time, without having to alter the at least two polarization orientations and/or regardless of the user viewing and/or capturing the image in magnified and/or standard view.

Additionally, as shown in FIG. 5, in some embodiments, polarizing light filter apparatus 300 may comprise at least one additional light source, such that an incident light (e.g., incoherent light) from the alternative light source may provide constructive interference, amplifying the backscattered light (e.g., coherent light). In this manner, in these other embodiments, the constructive interference from the at least one alternative light source may be viewed and/or captured by image capturing device 310 of polarizing light filter apparatus 300, simultaneously and/or in real-time. In some embodiments, the light source may be disposed within the removably attached split polarizer 306, such that the at least one additional light source light source 302 may backlight the split polarizer 306, allowing the incident light from the at least one additional light source to initially travel through the at least one polarizing filter 304, 308. In this manner, the incident light may be initial polarized.

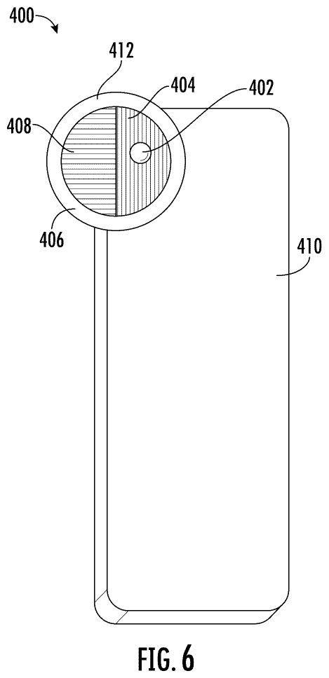

As shown in FIG. 6, in an embodiment, polarizing light filter apparatus 400 may be configured to be temporarily affixed to the image capturing device 410 (e.g., mobile computing device and/or camera) and/or at least one alternative computing device, via attachment component 412. Non-limiting examples of attachment component 412 may comprise the following a clamp, a magnet, an adhesive, or any attachment device that may be known in the art. For ease of reference, the exemplary embodiment described herein refers to an adhesive, but this description should not be interpreted as exclusionary of other attachment components 412.

As such, in an embodiment, the split polarizer 406 may be configured to be temporarily affixed to a mobile computing device, such that the at least one polarizing filter 404, 408 may be disposed about at least a portion of light source 402. In this manner, light source 402 may comprise the light fixture associated with image capturing device 410 (e.g., mobile computing device) and/or the at least one alternative computing device. In this embodiment, when the user takes at least one photo and/or records at least one video, via image capturing device 410, the incident light (e.g., incoherent light and/or coherent light) from light source 402 may translate through the split polarizer 406, the at least two polarization orientations, via at least one polarizing filter 404, 408, of the backscattered light (e.g., coherent light) of the structure viewed by the user may be displayed within the image and/or recorded view by image capturing system 410. In this embodiment, the at least two polarization orientations (e.g., the first polarization orientation and/or the second polarization orientation), via at least one polarizing filter 404, 408 of split polarizer 406, may be viewed simultaneously and/or in real time.

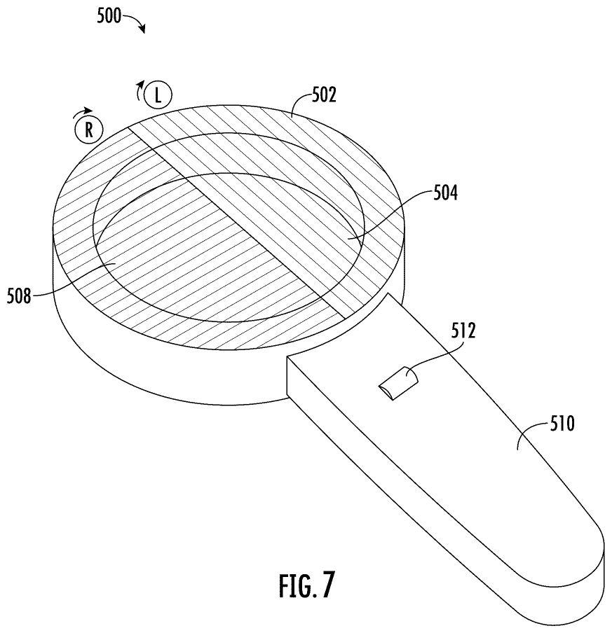

FIG. 7 an exemplary configuration of polarizing light filter apparatus 500, according to an embodiment of the present disclosure. As such, in an embodiment, polarizing light filter apparatus 500 may comprise a handheld light 510. Non-limiting examples of handheld light 510 may comprise an electronic torch, a flashlight, and/or any light apparatus known in the art. For ease of reference, the exemplary embodiment described herein refers to a flashlight, but this description should not be interpreted as exclusionary of other handheld lights 510. Accordingly, in this embodiment, the split polarizer 506 of polarizing light filter apparatus 500 may be integrated within handheld light 510, such that light source 502 may encapsulate split polarizer 506, light source 510 being disposed about a perimeter of split polarizer 506. In this manner, with light source 510 disposed about the perimeter of split polarizer 506, polarizing light filter apparatus may allow the user to view the structure through the at least one polarization filter 504, 506, via split polarizer 506, when light source 502 is activated. Moreover, light source 502 may provide the incident light (e.g., incoherent light and/or coherent light), which may then be circularly polarized in at least two polarization orientations. As such, polarizing light filter apparatus 500 may be configured to translate the polarized light onto the structure, such that the polarized light may interact with the structure. Subsequent to the polarized light interacting with the structure, the polarized backscattered light may travel back toward the same polarizing filter 504, 508 of split polarizer 506 where the backscattered light orientation may be maintained, allowing the user to view the structure and/or environment in real time.

In some embodiments, polarizing light filter apparatus 500 may be communicatively coupled to at least one computing device and/or image capturing device, such that the user may view and/or record the image and/or video on the viewing window of image capturing device and/or the display device associated with the computing device. In this manner, as shown in FIG. 7, the user may activate image capture and/or video recording via an activation button 512 disposed about at least one portion of handheld light 510 of polarizing light filter apparatus 500.

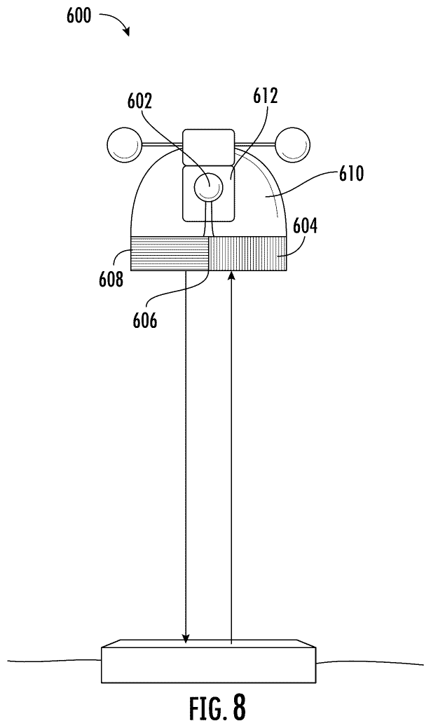

In addition, as shown in FIG. 8, in an embodiment, polarizing light filter apparatus 600 may comprise an aerial vehicle 610. In this embodiment, split polarizer 606 of polarizing light filter apparatus 600 may be temporarily affixed to at least a portion of a base of aerial vehicle 610. Non-limiting examples of aerial vehicle 610 may comprise a drone, an airplane, a blimp, a satellite, a vertical take-off and landing (VTOL) vehicle, a weather balloon, and/or any machine capable of flight known in the art. For ease of reference, the exemplary embodiment described herein refers to a drone, but this description should not be interpreted as exclusionary of other aerial vehicles 610.

In this embodiment, polarizing light filter apparatus 600 may comprise at least one receiver 612 such that the backscattered light from a structure may be received by at least one processor of aerial vehicle 610. In this manner, at least one image and/or a video may be obtained and/or recorded comprising the at least two polarization orientations (e.g., first polarization orientation and/or the second polarization orientation), via the at least one polarizing filter 604, 608 of split polarizer 606, of polarizing light filter apparatus 600, simultaneously and/or in real time. Accordingly, the at least one receiver 612 and/or at least one processor of aerial vehicle 610 may be communicatively coupled to the computing device of polarizing light filter apparatus 600, such that the at least one obtained image and/or recorded video may be displayed via the display device associated with the computing device.

As shown in FIG. 8, In an embodiment, light source 602 of polarizing light filter apparatus 600 may also be disposed about at least a portion of the base of aerial vehicle 610. As such, light source 602 may output at least one coherent light (e.g., a laser), such that the coherent light may initially translate through the at least two polarization orientations of the at least one polarizing filter 604, 608 of split polarizer 606 and/or return through the same polarization orientation with minimal diffraction and/or no diffraction. Accordingly, in this embodiment, aerial vehicle 610 may be able to obtain at least one image and/or video comprising the at least one superficial structure presented in the environment (e.g., trees, plants, landscapes, buildings, vehicles, armored vehicles, nautical vehicles, and/or military structures), in addition to capturing the deeper structures in an environment (e.g., roads, trenches, cervices, and/or caves) and/or provide depth to the obtained image and/or recorded video of the environment or structure.

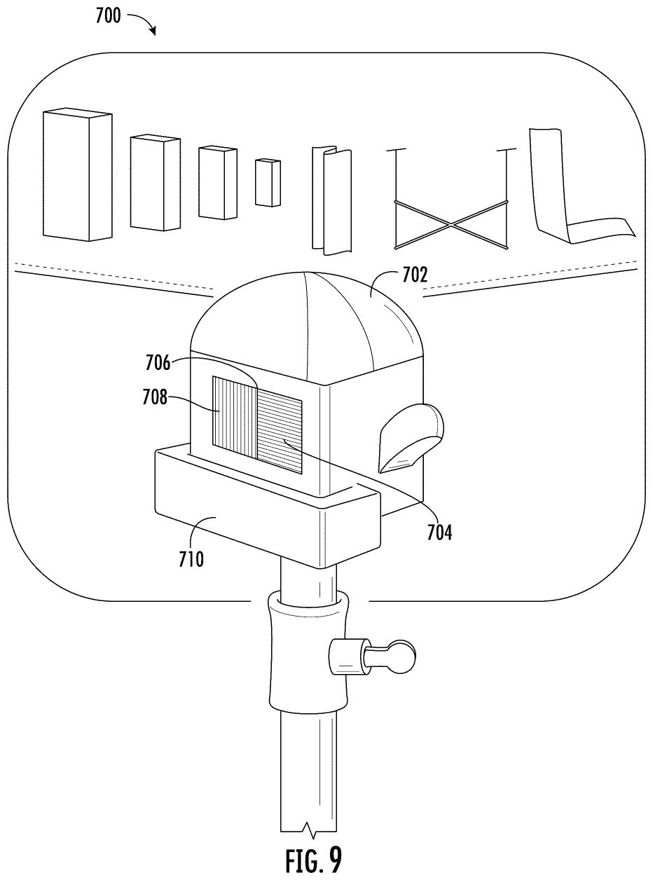

Furthermore, as shown in FIG. 9, in an embodiment, polarizing light filter apparatus may comprise a survey system 710. In this embodiment, survey system 710 may comprise light source 702 configured to output a coherent light (e.g., laser), such that the coherent light may translate through split polarizer 706 onto the structure. In this manner, polarizing light filter apparatus 700 may be configured to capture the backscattered light from the structure via survey system 710. In this embodiment, the user may look through the surveyor window of survey system 710, such that the user may view, in real-time, the at least two polarization orientations (e.g., first polarization orientation and/or the second polarization orientation), via the at least one polarizing filter 704, 708 of split polarizer 706, of polarized light simultaneously and/or in real time.

For example, in some embodiments, as the user is attempting to survey a floor—such as for leveling purposes—light source 702 may provide the user with information that the floor is level. Additionally, in this example, in these other embodiment, the at least two polarization orientations of polarized light, via split polarizer 706, may provide the user with the depth of the floor, such that the user may determine if any blemishes and/or flaws exist in a flooring material. As such, in some embodiments, surveyor system 710 of polarizing light filter apparatus 700 may be configured to obtain an image and/or record a video, such that the at least on polarization orientation of polarized light may be viewed simultaneously on the same image, such that image analysis may be optimized, as the user may not have to take two unique images and/or alter between the at least two polarization orientations and/or at least on alternative polarization orientation, via the at least one polarizing filter 704, 708 of split polarizer 706. Additionally, in some embodiments, surveyor system 710 may be communicatively coupled to the computing device of polarizing light filter apparatus 700, such that the at least one obtained image and/or recorded video may be displayed via the display device associated with the computing device of polarizing light filter apparatus 700.

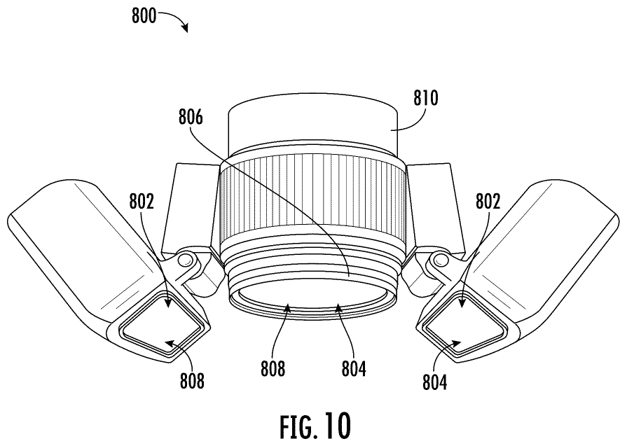

FIG. 10 depicts an exemplary configuration of polarizing light filter apparatus 800 comprising a photographic device 810, according to an embodiment of the present disclosure. In an embodiment, split polarizer 806 and/or light source 802 may be temporarily affixed to photographic device 810. In this embodiment, at least one polarizing filter 804, 808 may be removably affixed to light source 802, such that the incident light (e.g., incoherent light and/or coherent light) may be reorientated. Moreover, split polarizer 806 may also be temporarily affixed to a light receiver of photographic device 810. Non-limiting examples of the light receiver may comprise a sensor, lens, and/or any apparatus known in the art which may receive light to create an image and/or a video. For ease of reference, the exemplary embodiment described herein refers to a lens, but this description should not be interpreted as exclusionary of other light receivers.

Additionally, as shown in FIG. 10, in this embodiment, split polarizer 806 may be configured to convert the reoriented light into the at least two polarization orientations (e.g., the first polarization orientation and/or the second polarization orientation). In this manner, as the polarized incident light is emitted from light source 802 and hits the structure, the backscattered light may travel through the split polarizer into the light receiver of photographic device 810. As such, in this embodiment, the backscattered light may undergo a phase change prior to being captured by the light receiver, allowing the orientation of the backscattered light to convert from a linear wave to a circular wave. Moreover, in an embodiment, a first half of the backscattered light comprising a linear wave may enter at least one polarizing filter 804, 808, such that the first half of the linear backscattered light may comprise enter the first polarization orientation, while the second half of the linear backscattered light may comprise the second polarization orientation. In this manner, with the first half of the backscattered light comprising the first polarization orientation and the second half of the back scattered comprising the second polarization orientation, via the at least one polarizing filter 804, 808 or split polarizer 806, the obtained image and/or recorded video may comprise at least one frame comprising the subject as viewed through the at least two polarization orientations (e.g., first polarization orientation and/or the second polarization orientation) on opposite sides of the at least on frame. As such, the user may view the at least two polarization orientations on the at least one frame simultaneously and/or in real-time via the polarizing light filter apparatus 800. Additionally, in some embodiments, photographic device 810 may be communicatively coupled to the computing device of polarizing light filter apparatus 800, such that the at least one obtained image and/or recorded video may be displayed via the display device associated with the computing device of polarizing light filter apparatus 800.

### Method of Use

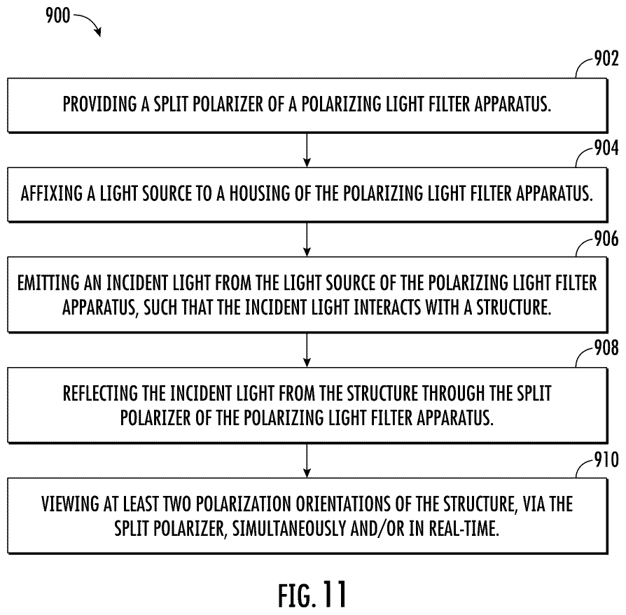

FIG. 11, in conjunction with FIGS. 1-10, exemplary flowchart depicting the steps of a method 900 for preparing a split configuration polarization view, according to an embodiment of the present disclosure. The steps delineated in FIG. 11 are merely exemplary of an order of preparing a split configuration polarization view. As such, the steps may be carried out in another order, with or without additional steps included therein.

As shown in FIG. 11, in conjunction with FIGS. 1-10, in an embodiment, the method 900 begins at step 902, in which a split polarizer comprising at least one polarizing filter, the at least one polarizing filter configured to output at least two polarization orientations (e.g., a first polarization orientation and/or a second polarization orientation) when a light is translated through the at least one polarizing filter, and/or a housing may be provided. The next step, step 904, may comprise affixing a light source to the housing of the polarizing light filter apparatus. Additionally, in this embodiment, the light source may be configured to be affixed to the housing on the opposite side of a structure, such that an incident light (e.g., incoherent light and/or coherent light) may pass through the at least one polarizing filter of the split polarizer and/or may be outputted directly onto a structure. As such the emitted incident light may be configured to interact and/or reflect off of the structure. In this manner, as stated above, subsequently, at step 906, the light source may be configured to emit the incident light, such that the incident light may interact with the structure. Accordingly, the incident light may then be reflected off of the structure, such that at least one superficial aspect and/or a depth of the structure may be being observed. Furthermore, at step 908, a backscattered light having the same polarization orientation as the incident light may be reflected from the structure and translate through at least one polarizing filter of split polarizer, the at least one polarizing filter comprising a first polarization orientation (e.g., parallel polarization) and/or a second polarization orientation (e.g., cross polarization). In this manner, the backscattered light may be configured to translate through the split polarizer maintaining the same polarization orientation that the incident light comprised after initially traveling through the split polarizer. Finally, at step 910, the at least two polarization orientations (e.g., first polarization orientation and/or the second polarization orientation), via the at least one polarizing filter of the split polarizer, may be viewed and/or obtained simultaneously and/or in real-time. As such, the at least two polarization orientations may be viewed via an image, a video, at least one viewing window of the polarizing light filter apparatus, and/or a display device of a computing device associated with the polarizing light filter apparatus.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### Incorporation by Reference

Harris; Michael D., Scottsdale, A., Dual polarizing hood, USPTO, Editor. 2013, GlobalMedia Group, LLC (Scottsdale, AZ): USA.
Patwardhan; Sachin V., Mount Tabor, N., Skin assessment using image fusion, USPTO, Editor. 2020, Canfield Scientific, Incorporated (Parsippany, NJ): USA.
Mullani; Nizar A., Sugar Land, T., Illuminated mirror employing cross and parallel polarization, USPTO, Editor. 2006, 3gen, LLC. (Dana Point, CA): USA.
Mullani; Nizar A., Sugar Land, T., Dermoscopy epiluminescence device employing cross and parallel polarization, in USPTO, USPTO, Editor. 2006, 3gen, LLC. (Dana Point, CA): USA.
Hanlon, K.L., Cross-polarised and parallel-polarised light: Viewing and photography for examination and documentation of biological materials in medicine and forensics. Journal of visual communication in medicine, 2018. 41(1): p. 3-8.
Adami, A., Fregonese, L., Helder, J., Rosignoli, O., Taffurelli, L., & Treccani, D. (2022). High-Resolution Digital Survey Of Floors: A New Prototype For Efficient Photogrammetric Acquisition. The International Archives of Photogrammetry, Remote Sensing and Spatial Information Sciences, 43, 745-752.
Zhou, Y., Xiong, B., Li, X., Dai, Q., & Cao, X. (2020). Lensless imaging of plant samples using the cross-polarized light. Optics Express, 28(21), 31611-31623.
Angheluţă, L., & Rădvan, R. (2020). 3D Digitization Of Translucid Materials In Cultural Heritage Objects: A Comparative Study Between Laser Scanning And Photogrammetry. Romanian Journal of Physics, 65, 906

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A polarizing light filter apparatus, the polarizing light filter apparatus comprising,
a housing comprising at least one viewing window;
at least one light source temporarily affixed to at least one portion of a surface of the housing, the at least one light source configured to output an incident light toward a structure;
a split polarizer temporarily affixed to at least one alternative portion of the surface of the housing, the split polarizer being in mechanical communication with the at least one viewing window;
wherein the split polarizer is configured to convert an orientation of the incident light into at least two polarized orientations; and
wherein when the incident light is outputted toward the structure, the split polarizer is configured to receive a reflected incident light, allowing a user to view the at least two polarized orientations of the structure, in real-time.

2. The polarizing light filter apparatus of claim 1, wherein the split polarizer comprises a first polarizing filter, a second polarizing filter, or both.

3. The polarizing light filter apparatus of claim 2, wherein the first polarizing filter comprises a counterclockwise polarization.

4. The polarizing light filter apparatus of claim 3, wherein the second polarizing filter comprises a clockwise polarization.

5. The polarizing light filter apparatus of claim 4, wherein the first polarizing filter is configured to highlight at least one superficial aspect of the structure.

6. The polarizing light filter apparatus of claim 5, wherein the second polarizing filter is configured to highlight at least one depth aspect of the structure.

7. The polarizing light filter apparatus of claim 1, further comprising an image capturing device in mechanical communication with the at least one viewing window, the split polarizer, or both.

8. The polarizing light filter apparatus of claim 7, wherein the image capturing device comprises a light receiver configured to obtain, record, or both the polarized incident light translated through the split polarizer, whereby the at least two polarized orientations of the structure are displayed simultaneously, in real-time, within an image, a video, or both.

9. The polarizing light filter apparatus of claim 8, further comprising a computing device having at least one processor communicatively coupled to the image capturing device.

10. The polarizing light filter apparatus of claim 9, wherein subsequent to the light receiver obtaining, recording, or both the at least two polarized orientations of the structure within the image, the video, or both, the image capturing device is configured to transmit the at least one obtained polarized orientation of the structure to the computing device, whereby the computing device is configured to automatically display, in real-time, the at least one obtained polarized orientation of the structure on a display device associated with the computing device.

11. The polarizing light filter apparatus of claim 1, wherein the at least one light source is configured to output a coherent light.

12. The polarizing light filter apparatus of claim 11, wherein the coherent light comprises a laser.

13. A system for viewing, in real time, at least two polarized orientations of a structure, the system comprising:
a housing comprising at least one viewing window;
at least one light source temporarily affixed to at least one portion of a surface of the housing, the at least one light source configured to output an incident light toward a structure;
a split polarizer temporarily affixed to at least one alternative portion of the surface of the housing, the split polarizer being in mechanical communication with the at least one viewing window;
an image capturing device in mechanical communication with the at least one viewing window, the split polarizer, or both, the image capturing device comprising at least one light receiver;
wherein the split polarizer is configured to convert an orientation of the incident light into at least two polarized orientations, whereby when the incident light is outputted toward the structure, the split polarizer is configured to receive the reflected incident light; and
wherein the light receiver is configured to obtain, record, or both the polarized incident light translated through the split polarizer, whereby the at least two polarized orientations of the structure are displayed simultaneously, in real-time, within an image, a video, or both.

14. The system of claim 13, wherein the split polarizer comprises a first polarizing filter, a second polarizing filter, or both.

15. The system of claim 14, wherein the first polarizing filter comprises a counterclockwise polarization.

16. The system of claim 15, wherein the second polarizing filter comprises a clockwise polarization.

17. The system of claim 13, wherein the at least one light source is configured to output a coherent light.

18. The system of claim 13, further comprising a computing device having at least one processor communicatively coupled to the image capturing device.

19. The system of claim 18, wherein subsequent to the light receiver obtaining, recording, or both the at least two polarized orientations of the structure within the image, the video, or both, the image capturing device is configured to transmit the at least one obtained polarized orientation of the structure to the computing device, whereby the computing device is configured to automatically display, in real-time, the at least one obtained polarized orientation of the structure on a display device associated with the computing device.

20. A method for viewing, in real time, at least two polarized orientations of a structure, the method comprising:
providing a polarizing light filter apparatus, the polarizing light filter apparatus comprising:
a housing comprising at least one viewing window;
at least one light source temporarily affixed to at least one portion of a surface of the housing, the at least one light source configured to output an incident light toward a structure;
a split polarizer temporarily affixed to at least one alternative portion of the surface of the housing, the split polarizer being in mechanical communication with the at least one viewing window; and
wherein the split polarizer is configured to convert an orientation of the incident light into at least two polarized orientations;
emitting, via the at least one light source, the incident light, wherein the incident light is reflected off of the structure;
converting, via the split polarizer, an orientation of the reflected incident light into at least two polarized orientations as it translates through the split polarizer; and
viewing, via the at least one viewing window, in real-time, the at least two polarized orientations of the structure, wherein the at least two polarized orientations of the structure highlights at least one superficial aspect, at least one depth aspect, or both of the structure.
